(19) United States
(12) Patent Application Publication
(10) Pub. No.: US 2024/0196928 A1
(43) Pub. Date: Jun. 20, 2024

(54) FOOD FORMULATION WITH HIGH PROTEIN CONTENT

(71) Applicant: OSTARA INNOVATIONS B.V., Arnhem (NL)

(72) Inventors: Panayiotis Voudouris, Nijmegen (NL); Maaike Nieuwland, Bennekom (NL); Walter Hendrik Heijnis, Wageningen (NL); Lenka Tonneijck-Srpova, Ede (NL)

(21) Appl. No.: 18/556,053

(22) PCT Filed: Apr. 21, 2022
(86) PCT No.: PCT/EP2022/060602

§ 371 Date: Oct. 18, 2023

(30) Foreign Application Priority Data
Apr. 21, 2021 (NL) 2028033

(51) Int. Cl. A23J 3/14; A23L 2/66; A23L 11/60

(52) U.S. Cl. CPC A23J 3/14; A23L 2/66; A23L 11/60

(57) ABSTRACT

This disclosure relates to a method for preparing a plant protein-based product, wherein the method comprises providing an aqueous slurry comprising plant protein, preferably chickpea protein, which can be obtained by high shear mixing the plant protein and water; subjecting the aqueous slurry to high pressure homogenization, wherein the step of high shear mixing is preferably repeated 2, 3, 4 or more times. The disclosure also relates to a plant protein-based product obtainable by the method.

### CROSS REFERENCE TO RELATED APPLICATIONS

This application is a national phase entry under 35 U.S.C. § 371 of International Patent Application PCT/EP2022/060602, filed Apr. 21, 2022, designating the United States of America and published as International Patent Publication WO 2022/223720 A1 on Oct. 27, 2022, which claims the benefit under Article 8 of the Patent Cooperation Treaty to Dutch Patent Application Serial No. 2028033, filed Apr. 21, 2021.

### TECHNICAL FIELD

This disclosure relates to a method for preparing a plant protein containing product, and to a plant protein containing product obtainable by the method.

### BACKGROUND

In the art, most of the high protein ready-to-drink formulations are based on animal derived proteins, in particular dairy proteins. Plant based ready to drink beverages have attracted a lot of interest due to the high consumer demand and for reasons relating to sustainability. A lot of effort has been put in from a scientific and also industrial standpoint toward development of such products and identifying the behavior of plant based proteins.

However, products containing high concentrations of plant based protein, such as drinks, functional liquid beverages, etc., for consumption, are currently developed to plant protein concentrations of up to 10-15 wt. %. Above this concentration range, physical behaviors are observed in such formulations which are non-attractive for consumer products; fluids become very viscous, form gels, become even semi-solid or incur pronounced (visible) phase separation, sedimentation and/or creaming while in storage.

Hydrolysis of the proteins can prevent some of the aforementioned issues, but also causes additional problems. During the hydrolysis the proteins break down to their individual building blocks (amino acids) which typically leads to bad odor and taste, as well as reduced nutritional value. Hydrolysis is also a costly method.

The above characteristics are not desirable by either industry (for reasons relevant to processing) or consumers.

There is an existing and in fact growing demand for plant protein-based liquid products with a concentration of high quality plant protein above e.g., 10-15 wt. %, for the mentioned applications. It is an objective of this disclosure to meet this and other demands.

### BRIEF SUMMARY

It was considered that chickpea protein, i.e., protein extracted and processed from chickpea, has not been fully explored for the applications mentioned above. Also, different processing steps (e.g., high pressure homogenization) were considered for obtaining plant based high protein functional liquids. Further, it was found that the combination of chickpea protein with very small amounts of other proteins (e.g., rice protein) offers a high level of nutritionally complete (amino acid wise) plant protein-based product with good nutritional profile and protein digestibility, which can be hormone and allergens free, gluten and lactose free and can be used as a non-GMO ingredient. The characteristics of chickpea protein are making it a surprisingly good candidate for a wide range of applications on plant based high protein liquids.

The method of the present disclosure consists of all natural, simple steps for obtaining high concentration of chickpea protein in solution/suspension—at a concentration of at least 15 wt. % or even up 35 wt. % protein, with respect to the total formulation. The product obtained after the processing steps of the method has viscosity, flow and stability characteristics well applicable for the above mentioned applications.

Possible applications for the product as obtained by the method of the present disclosure include as functional beverage, nutritional beverage, liquid nutrition, post-performance muscle recovery ready to drink product, supplemental nutrition drink, sports drink, ready-to drink infant formulation, dairy product substitute/analogues, athletic smoothie, or high protein smoothie. Other possible applications where the product obtained can be used is as plant based meat analogue, plant based cheese etc.

In comparison to prior art methods, the method of the present disclosure is less laborious and easily up scalable, uses equipment which is readily available in most food technology laboratories.

The yield, i.e., the percentage of protein in the starting material that ends up in the end product, that can be achieved with the method of the present disclosure can be up to 60, 70, 80, 90% or more, wherein chickpea isolate (commercially available 90% in protein) powder can be used as starting material.

### BRIEF DESCRIPTION OF THE DRAWINGS

FIG. 1: Viscosity values in mPa·s as a function of shear rate for 30% wt chickpea protein product after ULTRA-TURRAX® step and after 1st and 3^{rd} pass through HPH. Viscosity values are provided for measurements on which viscosity was measured increasing the shear rate from 0.1 s⁻¹ to 500 s⁻¹ and next measuring starting from 500 s⁻¹ and finishing at 0.1 s⁻¹. Viscosity values obtained from 0.1 to 500 s⁻¹ shear sweep are indicated by the top arrow while the viscosity values obtained from 500 to 0.1 s⁻¹ shear sweep (2) are indicated by the lower arrow.

FIG. 2: Viscosity as a function of measuring time for three samples; 30% wt chickpea protein sample after ULTRA-TURRAX® step and after 1^{st} and 2^{nd} pass through HPH as indicated by the legend. Viscosity is measured for 10 minutes at shear rate 0.1 s⁻¹ (step 1) followed by sudden change is the shear rate to 500 s⁻¹ for 10 minutes (step 2) followed by sudden change is the shear rate to 0.1 s⁻¹ for 10 minutes (step 3) and repetition of these 3 steps. At the graph is indicated the shear rate value of which the viscosity was measured for each step. Last, after measuring the viscosity at 500 s⁻¹ (step 6), the viscosity values for a range of shear rate 0.1-500 s⁻¹ starting from 0.1 s⁻¹ and going up to 500 s⁻¹ (shear sweep 3) and sequentially from 500 s⁻¹ going down to 0.1 s⁻¹ is shown.

FIG. 3 Volume weighted particle size distribution for three samples; 30% wt chickpea protein product after ULTRA-TURRAX® step and after 1st and 2nd pass through HPH as indicated by the legend.

FIG. 4 a) Viscosity values at shear rate 0.1 s⁻¹ for soy and chickpea protein at c=15% wt for samples obtained from three different steps of processing; after ULTRA-TURRAX® step and after 1^{st} and 2^{nd} pass through HPH as indicated by sample code on x-axis; 15% wt chickpea protein sample. b) Viscosity values at shear rate 500 s⁻¹ for soy and chickpea protein at c=15% wt for samples obtained from three different steps of processing; after ULTRA-TURRAX® step and after 1^{st} and 2^{nd} pass through HPH as indicated by sample code on x-axis; 15% wt chickpea protein sample.

FIG. 5 Chickpea, c=30 wt % (viscosity/shear rate)

FIG. 6 Chickpea, c=30 wt % (volume/particle size)

FIG. 7 Canola protein (1)— Puratein® HS, c=30 wt % (volume/particle size)

FIG. 8 Canola protein (1)— Puratein® HS, c=30 wt % (viscosity/shear rate)

FIG. 9 Canola protein (2)— Puratein® C, c=30 wt % (volume/particle size)

FIG. 10 Canola protein (2)— Puratein® C, c=30 wt % (viscosity/shear rate)

FIG. 11 Lupin protein, c=30 wt % (volume/particle size)

FIG. 12 Lupin protein, c=30 wt % (viscosity/shear rate)

FIG. 13 WPI, c=30 wt % (viscosity/shear rate)

FIG. 14 different proteins, 30 wt. % (viscosity at 0.1 s⁻¹)— As can be seen, for all plant based samples our technology seems to have the same effect and have higher impact (reducing the viscosity and decreasing the particle size) for the case of chickpea protein isolate.

FIG. 15 different proteins, 30 wt. % (viscosity at 500 s⁻¹)— Pea protein is not included in this comparison plots as was not possible to achieve a liquid like sample using 30% wt pea protein— Instead a solid like sample was achieved at 30% wt pea protein.

FIG. 16 Pea protein c=7.5 wt % (volume/particle size)

FIG. 17 Pea protein c=7.5 wt % (viscosity/shear rate)

FIG. 18 WPI (Whey protein isolate), c=30 wt % (volume/particle size)

### DETAILED DESCRIPTION

This disclosure relates to a method for preparing a plant protein containing product, preferably a chickpea protein containing product, wherein the method comprises the steps of:
a) providing an aqueous slurry comprising plant protein, preferably obtained by high shear mixing plant protein, preferably chickpea protein, with aqueous medium;
b) subjecting the aqueous slurry as obtained in step a) to high pressure homogenization.

The plant protein is preferably chosen from chickpea protein, rice protein, pea protein, lentils protein, and/or fava bean protein. In a most preferred embodiment, the plant protein is chickpea protein. Chickpea protein can be obtained from chickpeas (Cicer arietinum) using an extraction process as known by the skilled person. The extraction process can be based either on the isoelectric pH point, air classification, or on enzymatic treatment and separation. Chickpeas in their natural state contain about 16-24% protein, as well as starch, dietary fiber, iron, calcium and additional minerals.

The plant protein e.g., chickpea protein, according to the present disclosure may be comprised in a (natural) source material, such as a chickpeas, rice, etc., which may comprise at least 30, 40, 50, 60, 70, 80, 90 wt. % plant protein, with respect to the weight of the source material.

In step a), the ratio between plant protein (e.g., chickpea protein) weight (which may contain water) and the added aqueous medium weight may be between 20:80 and 80:20. Preferably, the aqueous slurry comprises at least 5, 6, 7, 8, 9, 10, 11, 12, 13, 14, 15, 16, 17, 18, 19, 20, 25, 30, 35 wt. % plant protein (e.g., chickpea protein), with respect to the weight of the slurry.

### High Shear Mixing

In a preferred embodiment, the present disclosure relates to the use of high shear mixing, for example, by using a high shear mixer. A high-shear mixer disperses, or transports, one phase or ingredient (liquid, solid, gas) such as plant protein into a main continuous phase (liquid, e.g., aqueous medium). A rotor or impeller, together with a stationary component known as a stator, or an array of rotors and stators, is used either in a tank containing the solution to be mixed, or in a pipe through which the solution passes, to create shear. A high-shear mixer can thus be used to create emulsions, suspensions, dispersions, and granular products. It can be used for emulsification, homogenization, particle size reduction, and dispersion. The term “high shear mixing” is well-recognized by the skilled person, but may in the present disclosure also replaced by “shear mixing” or “mixing” as long as the aqueous slurry in step a) can be obtained. Fluid undergoes shear when one area of fluid travels with a different velocity relative to an adjacent area. A high-shear mixer uses a rotating impeller or high-speed rotor, or a series of such impellers or inline rotors, usually powered by an electric motor, to “work” the fluid, creating flow and shear. The tip velocity, or speed of the fluid at the outside diameter of the rotor, will be higher than the velocity at the center of the rotor, and it is this velocity difference that creates shear. Specific design factors include the diameter of the rotor and its rotational speed, the distance between the rotor and the stator, the time in the mixer, and the number of generators in the series, which can be varied by the skilled person in accordance with the application. Batch high-shear mixers as well as inline high-shear mixers may be used.

The slurry obtained in step a) can be defined as a mixture of water (aqueous medium) and solids.

In a preferred embodiment, the high shear mixing in step a) is performed with an ULTRA-TURRAX® IKAR t25 (IKAR-Werke Gmbh & Co. KG) high shear mixer. There are various options for industrial scale equivalents for the high pressure homogenizer to be used, with similar characteristics. Some example that could be used in the present disclosure include ULTRA-TURRAX® UTS, ULTRA-TURRAX® UTL (IKAR-Werke Gmbh & Co. KG) etc.

Preferably, the shear mixing in step a) is applied with at least 6000, 7000, 8000 rpm. Alternatively or at the same time, the shear mixing in step a) is applied with at most 20000, 15000, or 10000 rpm. These rpm values may be used, for example, for the mentioned ULTRA-TURRAX® IKAR t25 (IKAR-Werke Gmbh & Co. KG) high shear mixer, or the industrial scale equivalents as mentioned above. In addition or alternatively, the kinetic energy dissipation rate provided by the high shear mixer is in the range of from 0.5 to 25 kW/m³, relative to the total volume of suspension present in the system, more preferably from 0.5 to 10 kW/m³, most preferably from 0.5 to 5 kW/m³, and in particular, from 0.5 to 2.5 kW/m³.

A high-shear mixer may disperse the ingredient (e.g., protein in the present case) into a main continuous phase liquid (e.g., demi-water). A rotor, together with a stationary component known as a stator, may be used in a tank/beaker containing the two components (protein ingredient and demi water) to be mixed, to create shear. Fluid undergoes shear when one area of fluid flows with a different velocity relative to an adjacent area. The high-shear mixer may use (high-speed) rotor, e.g., powered by an electric motor, to operate within the fluid, creating flow and shear. The tip velocity, or speed of the fluid at the outside diameter of the rotor, typically will be higher than the velocity at the center of the rotor, and it is this velocity difference that creates shear. The stator (as described previously) can create a close-clearance gap between the rotor and itself and can form an extremely high-shear zone for the material as it exits the rotor. The rotor and stator combined are often referred to as the mixing head, or generator. A large high-shear rotor-stator mixer may contain a number of generators. Key characteristics may include the diameter of the rotor and its rotational speed, the distance between the rotor and the stator, the time in the mixer, and the number of generators in the series, as can be placed different high shear mixers in series. Variables include the number of rows of teeth, their angle, and the width of the openings between teeth, as known by the skilled person.

### High Pressure Homogenization

In a preferred embodiment, the present disclosure uses high pressure homogenization. High pressure homogenization can be seen as a mechanical process that works to reduce particle size. Typically, a liquid is forced at high pressure through a very narrow nozzle. The higher the amount of energy applied during the homogenization process, the smaller the particle size. The term “high pressure homogenization” is well-recognized by the skilled person, but may in the present disclosure also replaced by “pressure homogenization” or “homogenization” as long as the plant protein (e.g., chickpea protein) containing product as defined herein can be obtained.

In a preferred embodiment, in step b) of the present method at least 2 cycles of high pressure homogenization are applied, preferably at least 3, 4, or 5 cycles of high pressure homogenization. An additional cycle means that the resulting product after a high pressure homogenization step is again subjected to a high pressure homogenization step.

In a particularly preferred embodiment, the high pressure homogenization in step b) is performed with a PandaPLUS 2000, GEA Niro Soavi (GEA Group Aktiengesellschaft). There are various options for industrial scale equivalent set-ups for the high pressure Homogenizer to be used, with similar characteristics. Some examples that could be used in the present disclosure include: GEA Ariete Homogenizer 5400, GEA Ariete homogenizer 5200, GEA Ariete homogenizer 3110, GEA Ariete homogenizer 3075, GEA Ariete homogenizer 3037 (GEA Group Aktiengesellschaft) etc.

Alternatively, or at the same time, the high pressure homogenization in step b) is performed by applying at least 800, 1000, 1200 bar and/or at most 3000, 2500 bar to force the aqueous slurry through a nozzle. In this or other embodiment, the nozzle may have a diameter of between 10-10000 nm, or between 10-1500 nm, or between 10-1000 nm, or between 50-1000 nm or between 100-500 nm; or between 1-10000 μm, or between 1-1500 μm, or between 1-1000 μm, or between 5-1000 μm or between 10-500 μm; or between 1-10000 μm, or between 1-1500 μm, or between 1-1000 μm, or between 5-1000 μm or between 10-500 μm.

High pressure homogenizing equipment may be equipped with plunger-like pumps and valves, or nozzles, or interaction micron chambers. There are mainly three traits that typically characterize effective homogenization: cavitation nozzle, impact valve and high shear liquid micro chamber. For this disclosure, a micron interaction chamber may be used. For this, the flow stream of the liquid may be split into two channels that are redirected over the same plane at right angles and propelled into a single flow stream. High pressure promotes a high speed at the crossover of the two flows, which results in high shear, turbulence, and cavitation over the single outbound flow stream. The key component of a high pressure homogenizer may include a homogenization unit and the high pressure pump unit. There typically is a specially designed fixed geometry inside the interaction chamber. Strokes of the piston in the high pressure pump unit drive the samples through the interaction chamber at high speed. In the chamber, materials may be subjected to mechanical forces such as high shearing, high-frequency oscillation, cavitation and convective impact, and corresponding thermal effects simultaneously. These mechanical and physiochemical effects can induce change in the physical, chemical, and particle structure of the materials. This may result in reduced particle size, achieving a homogenization effect.

By varying water content, the skilled person can produce different types of products with the method according to the present disclosure. For example, the plant protein containing product, e.g., the chickpea containing product as obtainable by the method according to the present disclosure, can be a drink, meat substitute or plant protein-based cheese. A meat substitute may be defined as a product comprising less than 70, 60, 50 wt. % by weight meat, while preferably having a protein content of more than 20, 30, 40, 50, 60, 70 wt. %. A plant protein containing cheese may be defined as a product comprising less than 70, 60, 50, 40, 30, 20, 10, 5 wt. % by weight milk protein, while preferably having a plant protein content of more than 20, 30, 40, 50, 60, 70 wt. %.

As a further step of the method, e.g., step c), the plant protein containing product obtained in step b) may be combined or mixed with rice protein. This may be done, for example, in a weight ratio between the existing plant protein, e.g., chickpea protein, and rice protein of between 100:1 and 5:1, more preferably between 50:1 and 10:1, most preferably between 20:1 and 10:1, such as about 15:1. In this way, the nutritional profile and protein digestibility of the product can be advantageously further improved.

The plant protein containing product, e.g., a chickpea protein containing product, as obtainable by the present disclosure, preferably has:
a plant protein content of at least 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35 wt. %, with respect to the weight of the chickpea protein containing product;
a viscosity at shear rate 0.1 s⁻¹ of between 100 and 7000 mPas, preferably between 300 and 1000 mPas, and preferably as measured by shear rate sweep method using couette geometry 17 cm on Anton Paar 302;
a viscosity at shear rate 500 s⁻¹ of between 20 and 70, preferably between 5 and 30 mPas, and preferably as measured by shear rate sweep method using couette geometry 17 cm on Anton Paar 302;
thixotropic effect of between 1500 and 6000 mPas, preferably between 100-600 mPas, and preferably as calculated by viscosity^{@4500s\hat{ }-1} (after applying shear at 500 s⁻¹ shear rate for 10 min)—viscosity^{@0.1s\hat{ }-1} (after applying shear at 0.1 s⁻¹ shear rate for 10 min); and/or
a volume weighted mean particle diameter (or average particle size) of below 100, 90, 80, 70, 60, 50, 40, 30, 20, 15, 14, 13, 12, 11, 10, 9, 8, 7, 6, 5 μm or between 1-100, 5-50, 5-25 or 10-15 or 5-10 μm as, for example, measured by a Mastersizer 2000.

The protein content can be determined, for example, by measuring the UV absorbance at 280 nm and convert this into the protein concentration using the Beer-Lambert law:

A=¿ cl
A is the absorbance (e.g., A₂₈₀)
ε is the appropriate molar extinction coefficient, M⁻¹ cm⁻¹— this can be found from the literature
c is concentration in M
I is the path length in cm— the length of the cuvette/microplate.

As described above, the Anton Paar 302 can be used to measure the viscosity of a sample at different shear rates. The geometry used is, for example, according to ISO 3219, e.g., using couette geometry 17 cm on Anton Paar 302, and/or using a concentric cylinder (couette) (also known in the art as bob-cup). The rotational speed of the bob (cylinder) is preset and produces a motor torque allowing rotation in the measuring bob. This torque has to overcome the viscous forces of the tested sample and is therefore a measure for its viscosity. The physical properties speed and torque are translated into the rheological properties shear rate and shear stress as the measurement is preferably performed using a standard measuring geometry e.g., concentric cylinders (bob-cup), according to ISO 3219, e.g., using couette geometry 17 cm on Anton Paar 302.

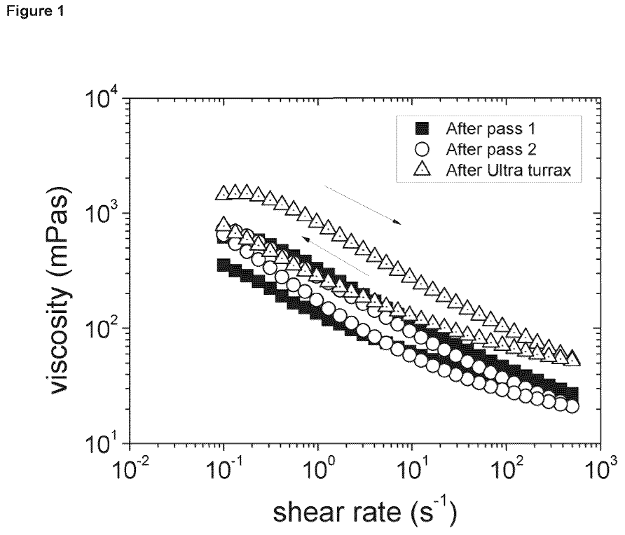

Sample can be loaded to the geometry up to the filling level mark inside the cup, according to the specifications of manufacturer. A volume of 4.7 ml of a sample can be measured with a precision pipette and loaded to the geometry. Application of manufacturer's protocol allows the collection of data points for shear stress in a range of shear rate 0.1-500 s⁻¹ starting from 0.1 s⁻¹ and going up to 500 s⁻¹ (shear sweep 1). Next data points for shear stress for the same range of shear rate (0.1-500 s⁻¹) are collected but in this case starting from 500 s⁻¹ and going down to 0.1 s⁻¹ (shear sweep 2). Next data points for shear stress in a range of shear rate 0.1-500 s⁻¹ starting from 0.1 s⁻¹ and going up to 500 s⁻¹ (shear sweep 3) and data points for shear stress for the same range of shear rate (0.1-500 s⁻¹) are collected but in this case starting from 500 s⁻¹ and going down to 0.1 s⁻¹ (shear sweep 4). From the shear stress and shear rate data which are obtained during the measurement, viscosity can be calculated automatically, (viscosity=shear stress/shear rate) using a routine of instrument's software. See also Acheson, D. J. (1990). Elementary Fluid Dynamics. Oxford University Press. ISBN 0-19-859679-0; Shear-thinning of molecular fluids in Couette flow, Physics of Fluids 29, 023103 (2017); doi.org/10.1063/1.4976319; Bharath V. Raghavan1 and Martin Ostoja-Starzewski. An overview of how this method was applied for other types of samples can be found here: Journal of Texture Studies, Volume 9, Issue 1-2, June 1978, Pages 3-3, RHEOLOGY OF PROTEIN DISPERSIONS. Viscosity parameter as physical parameter and not shear stress is discussed next. Representative examples of such measurements of viscosity for the samples, as described on the legend, are presented in FIG. 1; viscosity values are provided as function of shear rate as obtained from both shear sweep 1 and shear sweep 2.

The value of viscosity for the samples as measured from shear sweep 1, at shear rate 0.1 s⁻¹ of between 100 and 7000 mPas, preferably between 300 and 1000 mPas, and preferably as measured by shear rate sweep protocol using the above described method.

The thixotropic effect can be determined as follows. After applying the shear rate sweep method described above the sample can be further evaluated for its rheological properties and thixotropic behavior as following; viscosity can be constantly measured for 10 minutes at shear rate 0.1 s⁻¹ (step 1) next the shear rate is changed instantly to 500 s⁻¹ and viscosity can be measured at this shear rate for 10 minutes (step 2). Next the shear rate is changed instantly to 0.1 s⁻¹ and viscosity can be measured further for 10 minutes (step 3). Then the shear rate can be changed instantly to 500 s⁻¹ and viscosity can be measured for 10 minutes (step 4). Next the shear rate can be changed instantly to 0.1 s⁻¹ and viscosity can be measured further for 10 minutes (step 5). Next the shear rate can be changed instantly to 500 s⁻¹ and viscosity can be measured for 10 minutes (step 6).

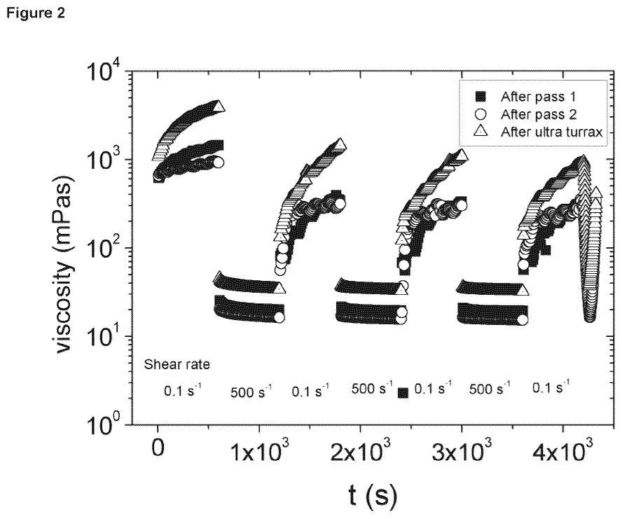

Last, after step 6, two shear sweeps can be applied; viscosity values for a range of shear rate 0.1-500 s⁻¹ starting from 0.1 s⁻¹ and going up to 500 s⁻¹ (shear sweep 5) and sequentially from 500 s⁻¹ going down to 0.1 s⁻¹ (shear sweep 5) can be obtained. The viscosity values from the above described steps are presented, for example, in FIG. 2.

From the first and the third step the viscosity value at 0.1 s⁻¹ can be used for quantification of thixotropic effect. Thixotropic effect of between 1500 and 6000 mPas, preferably between 100-600 mPas, and preferably can be calculated by viscosity at 500 s⁻¹ (after applying shear at 500 s⁻¹ shear rate for 10 min)— viscosity at 0.1 s⁻¹ (after applying shear at 0.1 s⁻¹ shear rate for 10 min).

The volume weighted mean participle diameter can be determined as follows by using Mastersizer 2000 (Malvern). References on application of this method in other type of systems include: All-natural oil-filled microcapsules from water-insoluble proteins, Filippidi, E., Patel, A. R., Bouwens, E. C. M., Voudouris, P., Velikov, K. P.; Advanced Functional Materials, 2014, 24(38), pp. 5962-5968; Effect of high-pressure homogenization on particle size and film properties of soy protein isolate, Xiaozhou Songa, Chengjun Zhoub, Feng Fuc, Zhilin Chenc, Qinglin Wu/Industrial Crops and Products 43 (2013) 538-544.

Mastersizer 2000 (Malvern) is making use the principles of static light/diffraction light scattering (SLS) and Mie theory to calculate the size of particles in an aqueous sample. During a laser diffraction measurement, the protein particles can be passed through a focused laser beam. These particles scatter light at an angle that is inversely proportional to their size. The angular intensity of the scattered light can then be measured by a series of photosensitive detectors. The scattering light intensity data along with the angular position of the detectors can be combined through Mie theory and the particle size distribution of the aqueous protein samples can be obtained.

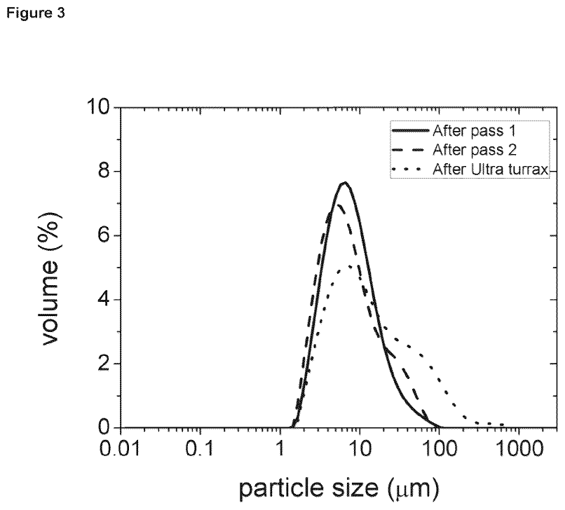

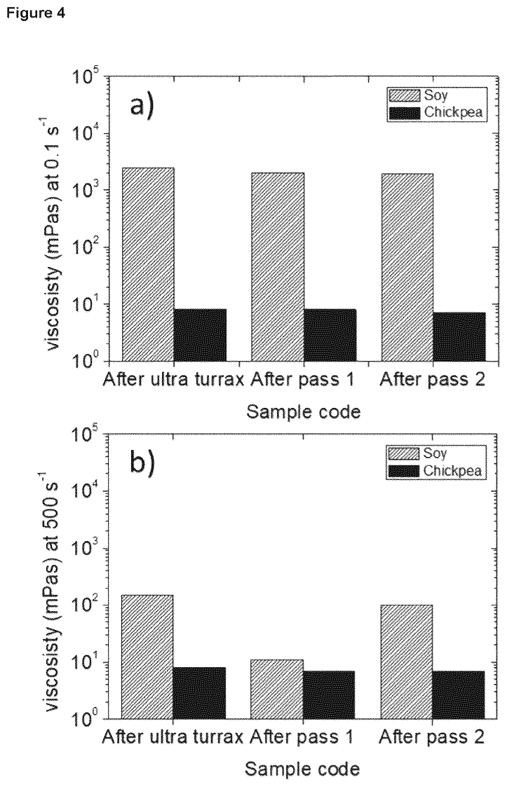

Few drops of the sample (about 1 ml in total) can be added to the water tank attached to Mastersizer 2000. Water of the tank preferably has been stirred at a speed of 1600 RPM allowing the sample to go through the scattering cell. The intensity of the sample can be measured through the obscuration parameter and can be set for each sample to 10-20%. The results can then be collected for the particle size distribution. As an example for a 30% wt protein sample after the ULTRA-TURRAX® step, and after 1^{st} and 3^{rd} pass of HPH their particle size distribution is presented at FIG. 3. From particle size distribution the average particle size D[4,3]—volume weighted mean diameter (ΣniDᵢ⁴)/(ΣniDᵢ³) is calculated using a routine of the instrument.

An (objective) key indicator for evaluating storage behavior is viscosity in combination with thixotropy.

The plant protein is preferably chosen from chickpea protein, rice protein, pea protein, lentils protein, and/or fava bean protein. The plant protein e.g., chickpea protein, according to the present disclosure may be comprised in a (natural) source material, such as a chickpeas, rice, etc., which may comprise at least 30, 40, 50, 60, 70, 80, 90 wt. % plant protein, with respect to the weight of the source material.

By varying water content in the plant protein containing product, the skilled person can produce different types of products with the method according to the present disclosure. For example, the plant protein containing product, e.g., the chickpea containing product as according to the present disclosure, can be a drink, meat substitute or plant protein-based cheese.

The plant protein containing product according to the present disclosure may further comprise rice protein, for example, in a weight ratio between the existing plant protein, e.g., chickpea protein, and rice protein of between 100:1 and 5:1, more preferably between 50:1 and 10:1, most preferably between 20:1 and 10:1, such as about 15:1. In this way, the nutritional profile and protein digestibility of the product can be advantageously further improved.

The plant protein containing product according to the present disclosure may further comprise fat, calcium, carbohydrates, salt, and/or potassium.

In this document and in its claims, the verb “to comprise” and its conjugations is used in its non-limiting sense to mean that items following the word are included, but items not specifically mentioned are not excluded. In addition, reference to an element by the indefinite article “a” or “an” does not exclude the possibility that more than one of the element is present, unless the context clearly requires that there be one and only one of the elements. The indefinite article “a” or “an” thus usually means “at least one.”

The following Examples illustrate the different embodiments of the disclosure.

### Example 1

The method according to the present disclosure is preferably 100% natural, i.e., preferably does not involve chemically processed components. In a preferred embodiment, the method comprises simple steps for obtaining a high concentration of chickpea protein in solution/suspension— at a protein concentration 15% wt≤ c≤ 35% wt (as high as c=35% wt). In this Example, the samples after the processing steps are evaluated on viscosity, flow and stability characteristics.

An example description of the present method is provided next:

### Steps:

### 1) Dissolution/Dispersion of Chickpea Protein Isolate (Commercially Available Chick.P S930, Agrinnovation Ltd.) in Water:

Amount of powder (Chick.P S930) and water are weighted for target concentrations 15-35 wt. % protein in the sample (protein content of Chick.P S930 is 90 wt. %). Total amount of sample 300 g.

Demi water is transferred into 500 ml beaker and ULTRA-TURRAX® IKA® t-25 (IKAR-Werke Gmbh & Co. KG) is immersed to water. Next, ULTRA-TURRAX® is turned on, operating at 8000 RPM (high shear mixing) and (pre weighted) powder of protein isolate Chick.P S30 is gradually added to the beaker. Within 6 minutes all pre weighted powder has been added in the beaker.

After that, 3 min at 8000 RPM ULTRA-TURRAX® is further applied to the sample so to reassure an homogeneous dispersibility of the powder into the sample.

From this step is obtained a slurry— small amount of the sample coming from this step is removed and placed into a 60 ml plastic container to be analyzed from analytical techniques.

It was also tried to perform step 1) using soy protein. However, for soy protein using the same concentrations as with Chickpea, it was not possible to perform all the steps of the process. The samples after the ULTRA-TURRAX® step were very viscous and it was not possible to perform the passes using the HPH. The same processing methods for Soy (as for chickpea) were applied using a much lower concentration 15% wt. The results for 15% wt soy protein product after ULTRA-TURRAX® step and after 1^{st}, 2^{nd} and 3rd pass through HPH are presented in the next table:

TABLE 1

| | Viscosity | Viscosity |
|---|---|---|
| | at 0.1 s⁻¹ | at 500 s⁻¹ |
| Sample code | (mPa · s) | (mPa · s) |
| Soy protein | 6000 | 190 |
| 15% wt_turrax | | |
| Soy protein | 5700 | 200 |
| 15% wt_pass1 | | |
| Soy protein | 5800 | 190 |
| 15% wt_pass2 | | |
| Soy protein | 5850 | 210 |
| 15% wt_pass3 | | |

Also, use of maize protein, rice protein, pea protein, wheat protein, sorghum protein, almond protein, and milk protein led to inferior results, making the selection for chickpea protein surprisingly stand out.

Then, the slurry is subjected to the next processing step:

### 2) High Pressure Homogenization (HPH)

The prepared slurry from step 1 is processed with high pressure homogenizer (PandaPLUS 2000, GEA Niro Soavi (GEA Group Aktiengesellschaft)) at 1200bar (for each pass). From the outcome of the HPH small amount of sample is removed and placed on plastic 60 ml container to be further analyzed— pass 1.

The rest of the sample is kept into a container and then further passed through the homogenizer for another HPH step— pass 2.

The above is repeated for total 4 passes from homogenizer.

### 3) Evaluation of Properties— Analytical Techniques

All samples after preparation are kept in the fridge at 4° C. overnight and the next day are subjected to a series of analytical experiments:
Evaluation of their flow characteristics using rheological protocols-experiments were performed using— bob-cup (Concentric cylinder system with diameter 17 mm) (Anton Paar GmbH). Anton Paar 302 was used to measure the viscosity of samples at different shear rates. Geometry used is a (couette)—concentric cylinder (also known in the art as bob-cup). The rotational speed of the bob (cylinder) is preset and produces a certain motor torque that is needed to rotate the measuring bob. This torque has to overcome the viscous forces of the tested substance and is therefore a measure for its viscosity. The physical properties speed and torque are translated into the rheological properties shear rate and shear stress as the measurement is performed using a standard measuring geometry according to ISO 3219.

Sample is loaded to the geometry up to the filling level mark inside the cup, according to the specifications of manufacturer. A volume of 4.7 ml of our samples was measured with a precision pipette and loaded to the geometry.

Protocol/Tests applied:

After applying a conditional step for 1 min at shear rate=0.1 s⁻¹:
a) Flow curves obtained from shear rate ramp from 0.1 s⁻¹ till 500 s⁻¹ and then from 500 s⁻¹ till 0.1 s⁻¹. This step was applied for 4 sequential times.

After the above step applied the following step:
b) viscosity measurement at shear rate=0.1 s⁻¹ for 10 min then sudden/immediate change of shear rate to value 500 s⁻¹, and repetition of the above test for 3 sequential times.
Evaluation of particle size distribution

a)
Equilibration/conditioning step 1 min at shear rate=0.1 s⁻¹ on which no collection of data was obtained.
Viscosity as a function of shear rate for range 0.1-500 s⁻¹ starting from 0.1 s⁻¹ and going up to 500 s⁻¹ (shear sweep 1).
Sequentially viscosity for the same range of shear rate (for range 0.1-500 s⁻¹) starting from 500 s⁻¹ and going down to 0.1 s⁻¹ (shear sweep 2).
Sequentially viscosity as a function of shear rate for range 0.1-500 s⁻¹ starting from 0.1 s⁻¹ and going up to 500 s⁻¹ (shear sweep 3).

Sequentially viscosity for the same range of shear rate (for range 0.1-500 s⁻¹) starting from 500 s⁻¹ and going down to 0.1 s⁻¹ (shear sweep 4).

b)
Viscosity constantly measured for 10 minutes at shear rate 0.1 s⁻¹ (step 1).
Shear rate is changed instantly to 500 s⁻¹ and viscosity was measured at this shear rate measured for 10 minutes (step 2).
Shear rate is changed instantly to 0.1 s⁻¹ and viscosity was measured for 10 minutes (step 3).
Shear rate is changed instantly to 500 s⁻¹ and viscosity is measured for 10 minutes (step 4).
Shear rate is changed instantly to 0.1 s⁻¹ and viscosity was measured further for 10 minutes (step 5).
Shear rate is changed instantly to 500 s⁻¹ and viscosity is measured for 10 minutes (step 6).
Viscosity as a function of shear rate for range 0.1-500 s⁻¹ starting from 0.1 s⁻¹ and going up to 500 s⁻¹ (shear sweep 5).
Viscosity as a function of shear rate for range 0.1-500 s⁻¹ starting from 500 s⁻¹ and going down to 0.1 s⁻¹ (shear sweep 5).

Particle size distribution on the prepared samples was obtaining using diffraction light scattering. Equipment used was Malvern—Mastersizer 3000 (Malvern Panalytical Ltd.). The following settings were applied for obtaining our measurement:
Stirrer speed: 1600 RPM
Obscuration range: 10-20%
Reading from average of 3 sequential measurements
R.I. particle: 1.470
Particle absorption index: 0.001
Dispersant water
Scattering model: Mie scattering general purposes
Cleaning circle: minimum rinse 3 times (no addition of surfactant)

The plant protein-based suspensions, after the different processing steps, for obtaining the (plant based) products, have been investigated regarding their particle size distribution. Particle size distribution was measured using Mastersizer 2000 (Malvern). The basics principles along with the method for obtaining PSD are described earlier in this document. For 30% wt chickpea protein sample, after the ULTRA-TURRAX® step, and after 1^{st}, 2^{nd} and 3^{rd} pass on HPH, their particle size distribution is presented at FIG. 3. In simpler form with respect to the full PSD as provided in FIG. 3, the PSD can be described from the parameters d (0.1), d(0.250), d (0.5), d(0.750), d (0.9).

The values of these parameters for the samples described are provided on the table next and their description is provided on the footnote of the table.

TABLE 2

| | d (0.1) | d(0.250) | d (0.5) | d(0.750) | d (0.9) | D [3, 2] | D [4, 3] |
|---|---|---|---|---|---|---|---|
| Sample code | (μm) | (μm) | (μm) | (μm) | (μm) | (μm) | (μm) |
| ChickP30% wt_turrax | 3.5 | 5.781 | 11.4 | 26.558 | 66.589 | 8.124 | 35.975 |
| Chick.P30% wt_pass1 | 2.8 | 4.138 | 6.914 | 12.401 | 23.127 | 5.686 | 13.278 |
| Chick.P30% wt_pass2 | 2.677 | 3.912 | 6.481 | 11.579 | 20.357 | 5.361 | 9.445 |
| Chick.P_30% wt_pass3 | 2.731 | 3.858 | 6.05 | 10.22 | 18.299 | 5.221 | 8.782 |

The definitions in table are as follows:
D_{(0.1)}: Distribution Percentile, 10% of the particle volume is smaller than the table value.
D_{(0.250)}: Distribution Percentile, 25% of the particle volume is smaller than the table value.
D_{(0.50)}: Distribution Percentile, median particle size.
D_{(0.750}: Distribution Percentile, 75% of the particle volume is smaller than the table value.
D_{(0.90)}: Distribution Percentile, 90% of the particle volume is smaller than the table value.
D[3,2]: Surface weighted mean particle size—diameter of a sphere that has the same volume/surface area ratio as a particle of interest (D³ᵥ)/(D²ₛ).
D [4,3]: Volume weighted mean diameter (ΣniDᵢ⁴)/(ΣniDᵢ³).

The results in short show the following:

When comparing samples of same concentration after each processing step: After ULTRA-TURRAX® test, the samples are having high viscosity and are not easily flowable. For the sample after the HPH step a clear reduction of viscosity, reduction of particle size and higher thixotropy are observed. Furthermore, increasing the amount of HPH passes, comparing sample obtained after pass 1→pass 4, a monotonic gradual decrease of viscosity, reduction of particle size and improved thixotropic behavior were observed; the higher the amount of passes the higher the reduction of viscosity, the higher the reduction of particle size and the better the thixotropic characteristics. See FIGS. 1, 2, and 3.

Finally, it is believed that an advantage of the current technology is that the processing method applied, based on what is available in literature, is not expected to have any effect regarding the nutritional characteristics of the (chickpea) protein.

### Example 2

### Materials Used:

Chickpea protein isolate—commercially available protein ingredient with Protein content, dry basis=90%
Whey protein isolate—commercially available protein ingredient with Protein content, dry basis=92%
Canola protein 1 isolate—commercially available protein ingredient with Protein content, dry basis=90%
Canola protein 2 isolate—commercially available protein ingredient with Protein content, dry basis=90%
Lupin protein isolate—commercially available protein ingredient with Protein content, dry basis=90%
Soy protein isolate—commercially available protein ingredient with Protein content, dry basis=91%
Calcium chloride
Sunflower oil
Water for all experiments is demi-water

Methods applied are the same as described in ‘Detailed description’
For Pea protein isolate regarding the methods only the following change was applied:
   Pea protein isolate, samples prepared at 30% wt. Samples appeared solid like and our technology was not applied and their evaluation was not performed.
   For pea protein isolate 15% wt samples prepared but they were very viscous and our technology was not applied and their evaluation was not performed.
   Pea protein isolate, samples prepared at 7.5% wt. Samples in that case were suitable to apply the technology and evaluation performed for these ones.
   Lupin protein isolate for sample without any high shear (sample as is) was very viscous to evaluate viscosity and particle size. Evaluation for this sample was skipped.
   for Soy protein isolate which was evaluated only at c=15% wt since at higher concentrations samples was very thick and not possible to apply the our technology.

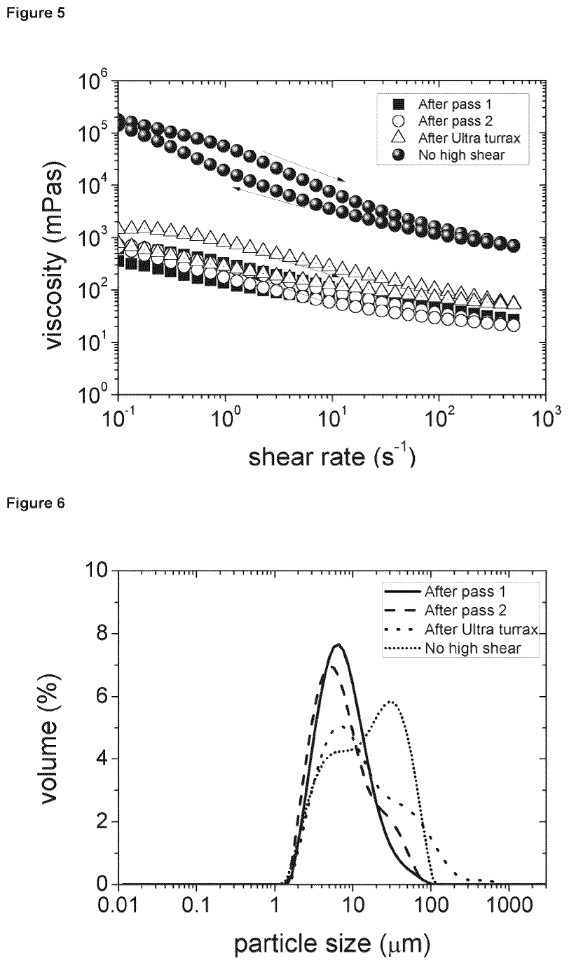

Results can be seen in FIGS. 5-18:

FIG. 5 Chickpea, c=30 wt % (viscosity/shear rate)

FIG. 6 Chickpea, c=30 wt % (volume/particle size)

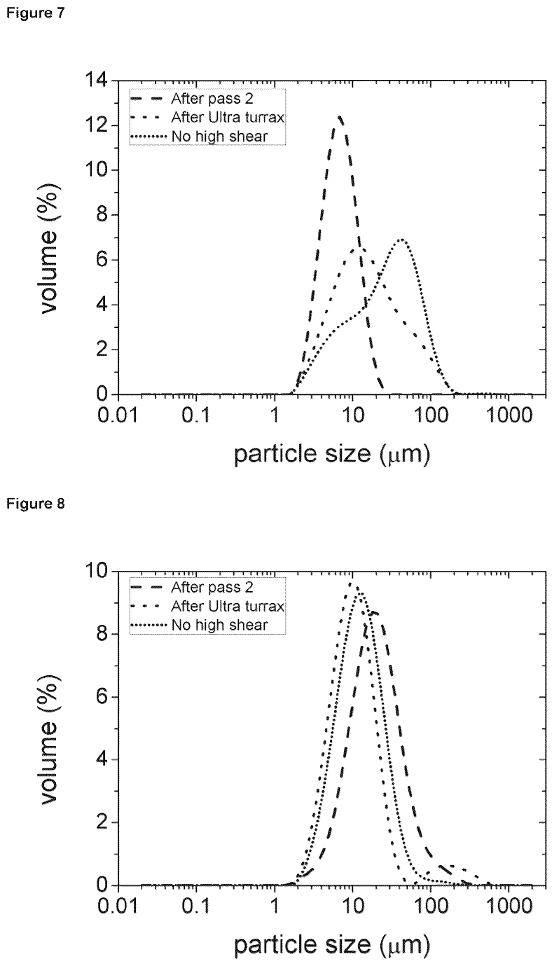

FIG. 7 Canola protein (1)—Puratein® HS, c=30 wt % (volume/particle size)

FIG. 8 Canola protein (1)—Puratein® HS, c=30 wt % (viscosity/shear rate)

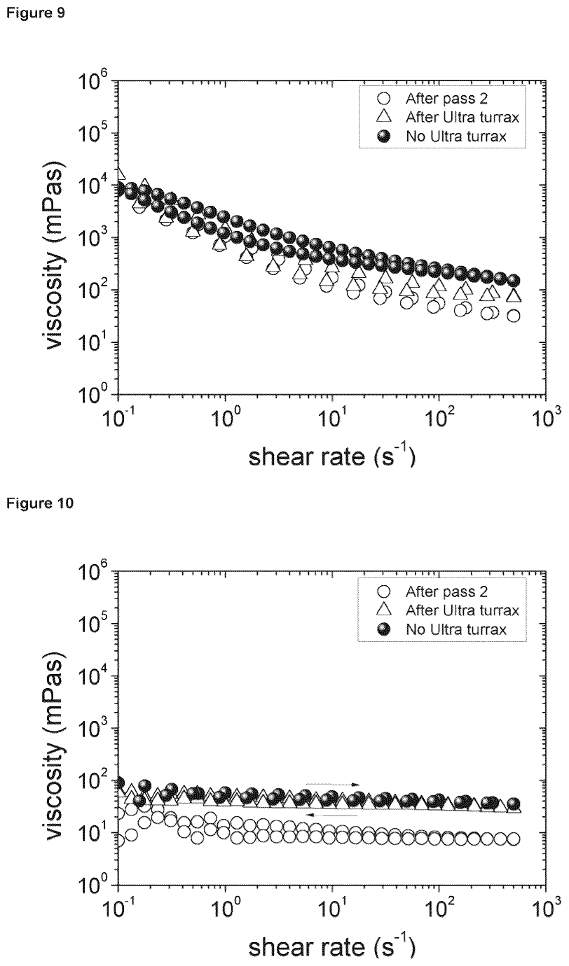

FIG. 9 Canola protein (2)—Puratein® C, c=30 wt % (volume/particle size)

FIG. 10 Canola protein (2)—Puratein® C, c=30 wt % (viscosity/shear rate)

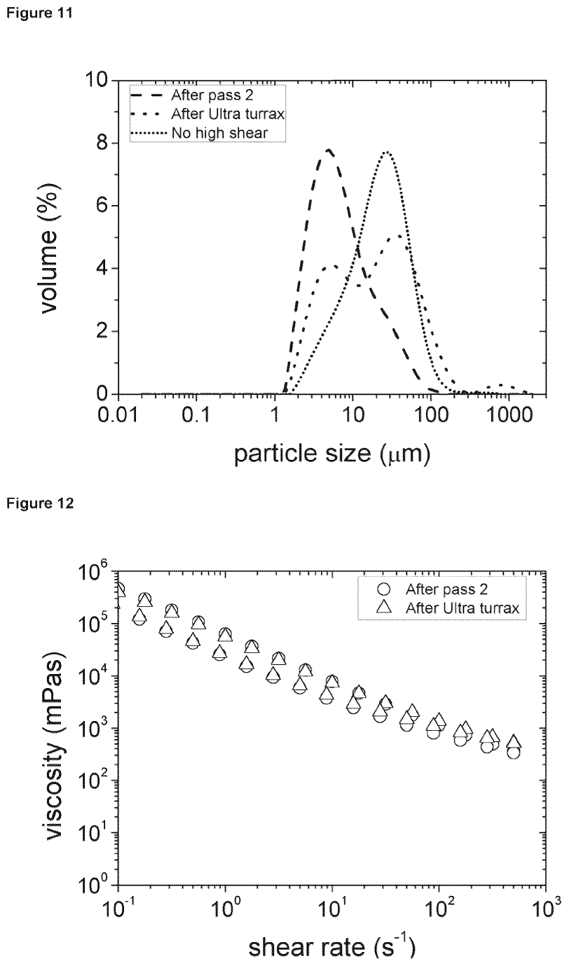

FIG. 11 Lupin protein, c=30 wt % (volume/particle size)

FIG. 12 Lupin protein, c=30 wt % (viscosity/shear rate)

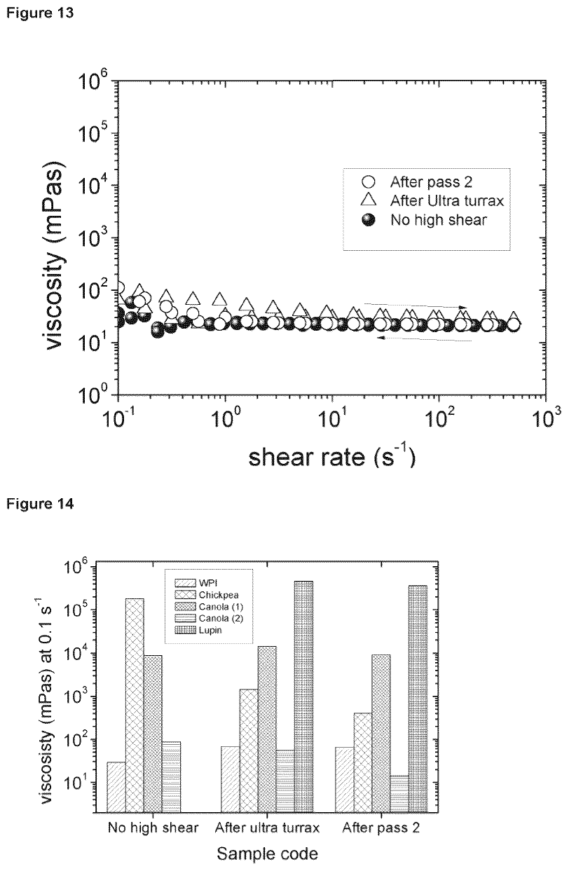

FIG. 13 WPI, c=30 wt % (viscosity/shear rate)

FIG. 14 different proteins, 30 wt. % (viscosity at 0.1 s⁻¹)—As can be seen, for all plant based samples our technology seems to have the same effect and have higher impact (reducing the viscosity and decreasing the particle size) for the case of chickpea protein isolate.-Pea protein and soy protein are not included in this comparison plot as was not possible to achieve a liquid like samples using 30% wt protein—Instead semi solid or solid like samples were achieved at 30% wt using these proteins.

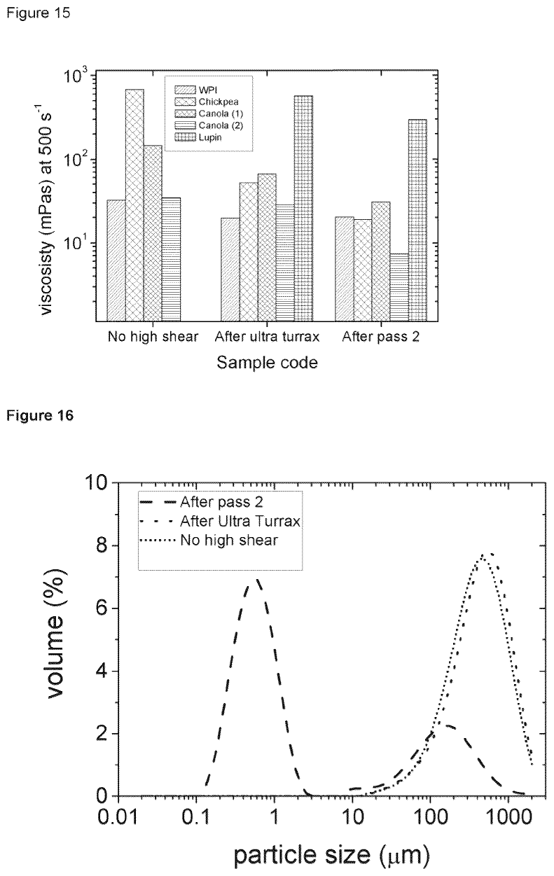

FIG. 15 different proteins, 30 wt. % (viscosity at 500 s⁻¹)—Pea protein and soy protein are not included in this comparison plot as was not possible to achieve a liquid like samples using 30% wt protein—Instead semi solid or solid like samples were achieved at 30% wt using these proteins.

FIG. 16 Pea protein c=7.5 wt % (volume/particle size)

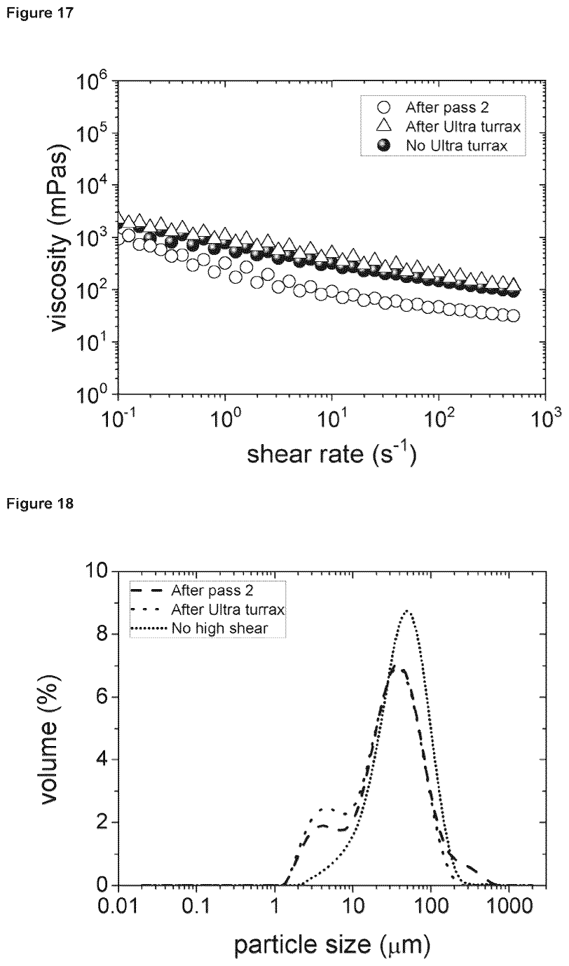

FIG. 17 Pea protein c=7.5 wt % (viscosity/shear rate)

FIG. 18 WPI (Whey protein isolate), c=30 wt % (volume/particle size)

TABLE 3
Chickpea - c = 30 wt %

| | d (0.1) | d (0.25.) | d (0.5) | d (0.75) | d (0.9) | D [3, 2] | D [4, 3] |
|---|---|---|---|---|---|---|---|
| Sample code | (μm) | (μm) | (μm) | (μm) | (μm) | (μm) | (μm) |
| chickpea 30% wt_no high shear | 3.74 | 6.9 | 17.3 | 36.2 | 57.1 | 9.51 | 24.6 |
| Chickpea 30% wt_turrax | 3.5 | 5.78 | 11.4 | 26.56 | 66.59 | 8.12 | 35.97 |
| Chickpea 30% wt_pass 1 | 2.8 | 4.14 | 6.91 | 12.4 | 23.12 | 5.69 | 13.28 |
| Chickpea 30% wt_pass 2 | 2.67 | 3.91 | 6.48 | 11.58 | 20.35 | 5.36 | 9.45 |
| Chickpea 30% wt_pass 3 | 2.73 | 3.85 | 6.05 | 10.22 | 18.29 | 5.22 | 8.78 |

TABLE 4
Canola protein (1) - Puratein ® HS, c = 30 wt %

| | d (0.1) | d (0.25.) | d (0.5) | d (0.75) | d (0.9) | D [3, 2] | D [4, 3] |
|---|---|---|---|---|---|---|---|
| Sample code | (μm) | (μm) | (μm) | (μm) | (μm) | (μm) | (μm) |
| Canola(1) | 5.8 | 12.4 | 30.1 | 55.1 | 84.5 | 15.1 | 39.7 |
| 30% wt_no high | | | | | | | |
| shear | | | | | | | |
| Canola(1) 30% | 4.9 | 8.2 | 15.6 | 32.6 | 66.9 | 11.1 | 27.2 |
| wt_turrax | | | | | | | |
| Canola(1) 30% | 3.8 | 5.1 | 7.2 | 10.3 | 13.8 | 6.4 | 8.2 |
| wt_pass 2 | | | | | | | |

| | Viscosity at | Viscosity at |
|---|---|---|
| | 0.1 s⁻¹ | 500 s⁻¹ |
| Sample code | (mPas) | (mPas) |
| Canola (1) 30% wt_no high shear | 8798.13 | 146.17 |
| Canola(1) 30% wt_turrax | 14465.72 | 66.04 |
| Canola (1) 30% wt_pass 2 | 9022.13 | 30.67 |

TABLE 5
Canola protein (2) - Puratein ® C, c = 30 wt %

| | d (0.1) | d (0.25.) | d (0.5) | d (0.75) | d (0.9) | D [3, 2] | D [4, 3] |
|---|---|---|---|---|---|---|---|
| Sample code | (μm) | (μm) | (μm) | (μm) | (μm) | (μm) | (μm) |
| Canola(1) | 8 | 12.7 | 20.9 | 34.7 | 57.3 | 15.7 | 29.9 |
| 30% wt_no high | | | | | | | |
| shear | | | | | | | |
| Canola(1) 30% | 5.5 | 8.33 | 13.3 | 21.1 | 31.7 | 10.6 | 17.3 |
| wt_turrax | | | | | | | |
| Canola(1) 30% | 4.8 | 7.08 | 11.1 | 17.4 | 27.7 | 9.2 | 24.1 |
| wt_pass 2 | | | | | | | |

| | Viscosity | Viscosity |
|---|---|---|
| | at 0.1 s⁻¹ | at 500 s⁻¹ |
| Sample code | (mPas) | (mPas) |
| Canola (2) 30% wt_no high shear | 88.81 | 34.35 |
| Canola(2) 30% wt_turrax | 55.35 | 28.64 |
| Canola (2) 30% wt_pass 2 | 14.23 | 7.36 |

TABLE 6
Lupin protein, c = 30 wt %

| | d (0.1) | d (0.25.) | d (0.5) | d (0.75) | d (0.9) | D [3, 2] | D [4, 3] |
|---|---|---|---|---|---|---|---|
| Sample code | (μm) | (μm) | (μm) | (μm) | (μm) | (μm) | (μm) |
| Canola(1) | 6.26 | 12.5 | 24.1 | 41.2 | 63.8 | 14.6 | 32.3 |
| 30% wt_no high | | | | | | | |
| shear | | | | | | | |
| Canola(1) 30% | 3.74 | 6.88 | 20.8 | 48.4 | 89.4 | 10 | 50.8 |
| wt_turrax | | | | | | | |
| Canola(1) 30% | 2.74 | 3.99 | 6.77 | 13.5 | 28.5 | 5.65 | 12.1 |
| wt_pass 2 | | | | | | | |

| | Viscosity | Viscosity |
|---|---|---|
| | at 0.1 s⁻¹ | at 500 s⁻¹ |
| Sample code | (mPas) | (mPas) |
| Lupin 30% wt_no high shear | n.a. | n.a. |
| Lupin 30% wt_turrax | 462078.9 | 570.1 |
| Lupin 30% wt_pass 2 | 362454.8 | 295.3 |

TABLE 7
WPI, 3 = 30 wt %

| | d (0.1) | d (0.25.) | d (0.5) | d (0.75) | d (0.9) | D [3, 2] | D [4, 3] |
|---|---|---|---|---|---|---|---|
| Sample code | (μm) | (μm) | (μm) | (μm) | (μm) | (μm) | (μm) |
| WPI 30% wt_no high shear | 15.1 | 27.6 | 47.6 | 76.6 | 113 | 30.1 | 58.1 |
| WPI 30% wt_turrax | 4.51 | 12.5 | 30.5 | 55.2 | 86.4 | 13.1 | 39.3 |
| WPI 30% wt_pass 2 | 5.24 | 16.4 | 34.9 | 63.4 | 109 | 15.1 | 53.5 |

| | Viscosity | Viscosity at |
|---|---|---|
| | at 0.1 s⁻¹ | 500 s⁻¹ |
| Sample code | (mPas) | (mPas) |
| WPI 30% wt_no high shear | 29.34 | 32.07 |
| WPI 30% wt_turrax | 69.41 | 19.64 |
| WPI 30% wt_pass 2 | 66.39 | 20.16 |

TABLE 8
Pea protein, c = 7.5 wt %

| | d (0.1) | d (0.25.) | d (0.5) | d (0.75) | d (0.9) | D [3, 2] | D [4, 3] |
|---|---|---|---|---|---|---|---|
| Sample code | (μm) | (μm) | (μm) | (μm) | (μm) | (μm) | (μm) |
| Pea 7.5% wt_no high shear | 19.1 | 33.5 | 56.4 | 88.6 | 126.6 | 37.4 | 66.2 |
| Pea 7.5% wt_turrax | 17.9 | 30.2 | 50.7 | 81.1 | 118.6 | 34.8 | 61.1 |
| Pea 7.5% wt_pass 2 | 0.1 | 0.15 | 0.25 | 10.8 | 30.2 | 0.2 | 8.8 |

| | Viscosity at | Viscosity at |
|---|---|---|
| | 0.1 s⁻¹ | 500 s⁻¹ |
| Sample code | (mPas) | (mPas) |
| Pea 7.5% wt_no high shear | 1624 | 113.1 |
| Pea 7.5% wt_turrax | 2004 | 87.8 |
| Pea 7.5% wt_pass 2 | 964 | 33.3 |

### Example 3

TABLE 9
Evaluation and comparison on the final product for preparing
plant based beverage at high protein concentrations c >15% wt

| | Drinkable | Flavor |
|---|---|---|
| Whey protein isolate (WPI) - | Good (thin, drinkable samples) | Good - Plain - suitable for |
| milk protein - reference | | beverages |
| Chickpea protein isolate | Good (thin drinkable samples) | Good - Plain - suitable for |
| | | beverages |
| Canola protein 2 (Puratein ® C) | Good (thin drinkable samples) | Not good - a lot of flavors - |
| | | smell not suitable for food |
| | | applications |
| Soy protein isolate | Not good (very thick, not drinkable- gel | Good - Plain - suitable for |
| | like samples) | beverages |
| Lupin protein isolate | Not good (very thick, not drinkable, | Not good - a lot of flavors |
| | gel/semi solid like samples) | |
| Canola protein 1 (Puratein ® | Not good (thick liquid - not drinkable | Not good - a lot of flavors - |
| HS) | samples) | smell not suitable for food |
| | | applications |
| Pea protein isolate | Not good (very thick, not drinkable/ | Good - Plain - suitable for |
| | solid like samples) | beverages |

Only reference (milk protein) and chickpea appear as good for both drinkability and flavor for preparing beverages at high protein concentrations: 35%>c>10% wt.

1.-8. (canceled)

9. A method of preparing a chickpea protein containing product having a chickpea protein content of at least 10 wt. %, wherein the method comprises
providing an aqueous slurry comprising chickpea protein obtained by mixing chickpea protein and aqueous medium using a high shear mixer, which high shear mixer comprises a rotor that together with a stator creates shear; and
subjecting the aqueous slurry to high pressure homogenization by applying at least 800 bar to force the aqueous slurry through a nozzle having a diameter of between 10-10,000 nm.

10. The method according to claim 9, wherein the high shear mixer applies at least 6,000 rpm.

11. The method according to claim 9, wherein at least two (2) cycles of high-pressure homogenization are applied.

12. The method according to claim 10, wherein at least two (2) cycles of high-pressure homogenization are applied.

13. The method according to claim 9, wherein the high-pressure homogenization is performed by applying at least 800 bar to force the aqueous slurry through the nozzle.

14. The method according to claim 10, wherein the high-pressure homogenization is performed by applying at least 800 bar to force the aqueous slurry through the nozzle.

15. The method according to claim 11, wherein the high-pressure homogenization is performed by applying at least 800 bar to force the aqueous slurry through the nozzle.

16. The method according to claim 9, wherein the chickpea protein containing product is a drink, meat substitute, or plant protein containing cheese.

17. The method according to claim 10, wherein the chickpea protein containing product is a drink, meat substitute, or plant protein containing cheese.

18. The method according to claim 11, wherein the chickpea protein containing product is a drink, meat substitute, or plant protein containing cheese.

19. A chickpea protein containing product produced by the method of claim 9, wherein the chickpea protein containing product has:
a chickpea protein content of at least 20 wt. % with respect to the weight of the chickpea protein containing product;
a viscosity at shear rate 0.1 s⁻¹ of between 100 and 5,000 mPas;
a viscosity at shear rate 500 s⁻¹ of between 20 and 70;
thixotropic effect of between 1,500 and 6,000 mPas; and
a volume weighted mean particle diameter of below 70 μm.

20. The chickpea protein containing product of claim 19, further comprising fat, calcium, carbohydrates, salt, and/or potassium.

21. The chickpea protein containing product of claim 19, wherein the chickpea protein-based product is a drink, meat substitute, or plant-based cheese.

22. The chickpea protein containing product of claim 20, wherein the chickpea protein-based product is a drink, meat substitute, or plant-based cheese.

23. A method of preparing a chickpea protein containing product having a chickpea protein content of at least 10 wt. %, the method comprising:
subjecting an aqueous slurry to high pressure homogenization by applying at least 800 bar to force the aqueous slurry through a nozzle having a diameter of between 10-10,000 nm,
wherein the aqueous slurry comprises chickpea protein obtained by mixing chickpea protein and aqueous medium using a high shear mixer, which high shear mixer has a rotor that together with a stator creates shear.

24. The method according to claim 23, wherein the high shear mixer in step a) applies at least 8,000 rpm.

25. The method according to claim 23, further comprising:
applying at least two (2) cycles of high-pressure homogenization.

26. The method according to claim 23, wherein the high-pressure homogenization is performed by applying at least 800 bar to force the aqueous slurry through the nozzle.

27. The method according to claim 23, wherein the chickpea protein containing product is a drink, meat substitute, or plant protein containing cheese.
